(19) United States
(12) Patent Application Publication
(10) Pub. No.: US 2026/0239496 A1
(43) Pub. Date: Aug. 13, 2026

(54) ION GEL ELECTRODE COMPOSITION FOR DIELECTRIC HEATER, METHOD FOR MANUFACTURING THE SAME, ION GEL ELECTRODE FOR DIELECTRIC HEATER, AND DIELECTRIC HEATER INCLUDING THE SAME

(71) Applicant: Korea University of Technology and Education Industry-University Cooperation Foundation, Cheonan-si (KR)

(72) Inventors: Jinwoo BAE, Seoul (KR); Seung Eun CHOI, Cheonan-si (KR); Seungju OH, Cheonan-si (KR)

(73) Assignee: Korea University of Technology and Education Industry-University Cooperation Foundation, Cheonan-si (KR)

(21) Appl. No.: 19/575,564

(22) Filed: Mar. 23, 2026

Related U.S. Application Data
(63) Continuation of application No. PCT/KR2026/001201, filed on Jan. 20, 2026.

(30) Foreign Application Priority Data
Feb. 13, 2025 (KR) 10-2025-0018598

(51) Int. Cl. H05B 6/54; C08F 220/28; C08K 5/3445

(52) U.S. Cl. CPC H05B 6/54; C08F 220/281; C08K 5/3445; C08F 2800/20; C08F 2810/20

(57) ABSTRACT

The present invention relates to an ion gel electrode composition for a dielectric heater, a method for manufacturing the same, an ion gel electrode for a dielectric heater, and a dielectric heater including the same. The ion gel electrode composition for a dielectric heater according to an embodiment of the present invention includes acrylamide (AAm), hydroxyethyl acrylate (HEA), a cross-linking agent, and an ionic liquid. An embodiment may further include ammonium persulfate (APS) as an initiator and tetramethyl ethylenediamine (TEMED) as a catalyst.

### CROSS-REFERENCE TO RELATED APPLICATION

This application is a continuation application under 35 U.S.C. § 111(a) of International Patent Application No. PCT/KR2026/001201, filed Jan. 20, 2026, which claims priority to Korean Patent Application No. 10-2025-0018598, filed Feb. 13, 2025, the entire contents of each of which are incorporated herein by reference.

### BACKGROUND

The present disclosure relates to an ion gel electrode composition for a dielectric heater, a method for manufacturing the same, an ion gel electrode for a dielectric heater, and a dielectric heater including the same.

The present disclosure is based on research results of the research project titled ‘Development of Plasticized Polymer-Based dielectrics and Ion Conductors and Their Application to Next-Generation Organic Electronic Devices Using 3D Printing’ (Research Institution: Korea University of Technology and Education Industry-Academic Cooperation Foundation, Research Period: May 1, 2025 to Apr. 30, 2026), conducted as part of the Individual Basic Research (Ministry of Science and ICT) program funded by the Ministry of Science and ICT and administered by the National Research Foundation of Korea.

A dielectric heater uses technology that generates heat by applying an electric field, thereby causing energy loss within a dielectric layer, and is used in various fields such as wearable devices, transparent displays, smart windows, and medical devices. A dielectric heater is generally composed of a polymer dielectric layer and an electrode layer, and the electrode layer applies an electric field to cause heat generation inside the dielectric layer.

An electrode layer applied to a typical dielectric heater is aqueous-based hydrogel, which has the problem of changes in resistance and reduced performance due to moisture evaporation caused by changes in humidity or temperature.

Prior art literature includes Korean Patent Laid-Open Publication No. 10-1995-0003377.

### SUMMARY

The present disclosure provides an ion gel electrode composition for a dielectric heater capable of manufacturing an ion gel electrode for a dielectric heater having high elongation and electrical stability, and a method for manufacturing the same.

In addition, the present disclosure provides excellent electrical properties and ion conductivity.

In addition, the present disclosure may provide uniform heat distribution and improved heater performance.

In accordance with an exemplary embodiment of the present invention, an ion gel electrode composition for a dielectric heater includes acrylamide (AAm), hydroxyethyl acrylate (HEA), a cross-linking agent, and an ionic liquid. An embodiment may further include ammonium persulfate (APS) as an initiator and tetramethyl ethylenediamine (TEMED) as a catalyst.

The acrylamide and the hydroxyethyl acrylate may have a weight ratio of 1:3 to 1:10.

The cross-linking agent may have a content of 0.3 mol % to 0.7 mol % based on the total content of the ion gel electrode composition for a dielectric heater.

The ionic liquid may have a content of 300 parts by weight to 500 parts by weight based on 100 parts by weight of the hydroxyethyl acrylate.

In accordance with another exemplary embodiment of the present invention, a method for manufacturing an ion gel electrode composition for a dielectric heater includes mixing acrylamide (AAm), hydroxyethyl acrylate (HEA), a cross-linking agent, and an ionic liquid to prepare a first mixture, adding an initiator and a catalyst to the first mixture to prepare a second mixture, and curing the second mixture.

In accordance with another exemplary embodiment of the present invention, an ion gel electrode for a dielectric heater is manufactured using the above-described ion gel electrode composition for a dielectric heater.

In accordance with still another exemplary embodiment of the present invention, a dielectric heater includes a dielectric layer and an ion gel electrode for a dielectric heater disposed on each of one surface and the other surface of the dielectric layer. The ion gel electrode for a dielectric heater is the same as described above.

### BRIEF DESCRIPTION OF THE DRAWINGS

Exemplary embodiments can be understood in more detail from the following description taken in conjunction with the accompanying drawings, in which:

FIG. 1 is a conceptual diagram of a dielectric heater in accordance with an exemplary embodiment of the present invention;

FIGS. 2 to 4 show measurements of ion conductivity of an ion gel electrode;

FIGS. 5 to 7 show measurements of tensile strength of an ion gel electrode;

FIG. 8 shows results of thermogravimetric analysis of an ion gel electrode and a dielectric layer;

FIG. 9 shows results of a T-peel test of an ion gel electrode;

FIG. 10 shows results of measuring transmittance of an ion gel electrode and various laminates;

FIG. 11 shows evaluation of heat generation performance of a dielectric heater including an ion gel electrode;

FIG. 12 shows evaluation of heat generation performance of a dielectric heater including a hydrogel electrode;

FIG. 13 shows evaluation of heat generation performance of dielectric heaters, respectively including an ion gel electrode and a hydrogel electrode, under harsh conditions;

FIG. 14 shows measurements of capacitance of dielectric heaters respectively including an ion gel electrode and a hydrogel electrode;

FIG. 15 shows measurements of impedance changes of dielectric heaters, respectively including an ion gel electrode and a hydrogel electrode, under harsh conditions; and

FIG. 16 shows evaluation of durability of a dielectric heater including an ion gel electrode.

The reference numerals are as follows.
100: Dielectric heater,
110: Dielectric layer,
120: Ion gel electrode

### DETAILED DESCRIPTION OF EMBODIMENTS

Hereinafter, preferred embodiments of the present invention will be described as follows with reference to the accompanying drawings. However, embodiments of the present invention may be modified into various other forms, and the scope of the present invention is not limited to the embodiments described below. In addition, the embodiments of the present invention are provided in order to more fully describe the present disclosure to those with average knowledge in the art.

In accordance with an exemplary embodiment of the present invention, an ion gel electrode composition for a dielectric heater includes acrylamide (AAm), hydroxyethyl acrylate (HEA), a cross-linking agent, and an ionic liquid. An embodiment may further include ammonium persulfate (APS) as an initiator and tetramethyl ethylenediamine (TEMED) as a catalyst.

The acrylamide (AAm) serves as a substrate for forming a main polymer network of an ion gel electrode, and contributes to mechanical strength. The acrylamide is an amide derivative of acrylic acid, and has the molecular formula of C₃H₅NO.

In the present invention, the acrylamide undergoes radical polymerization initiated by an initiator (e.g., ammonium persulfate (APS)) and a catalyst (e.g., tetramethyl ethylenediamine (TEMED)), in which process the acrylamide, together with the hydroxyethyl acrylate (HEA), may form a gel polymer having a three-dimensional network structure. As a result, excellent stretchability and mechanical strength are provided. In addition, the polymer gel thus prepared has excellent adhesiveness, and thus may be fixed to a dielectric layer without being separated.

The hydroxyethyl acrylate (HEA), together with the acrylamide, serves as a substrate for forming a main polymer network of an ion gel electrode, and contributes to mechanical strength and elongation. The hydroxyethyl acrylate is an acrylic monomer, and has the molecular formula of C₅H₈O₃.

In the present invention, the hydroxyethyl acrylate, together with the acrylamide, forms a polymer network, thereby providing excellent stretchability and mechanical strength. As a result, a dielectric heater may have uniform heating capability throughout.

In an embodiment, the acrylamide and the hydroxyethyl acrylate may have a weight ratio 1:3 to 1:10, preferably 1:4 to 1:6. If the content of the acrylamide is too high, there is a problem in that stretchability is reduced, and if the content of the hydroxyethyl acrylate is too high, there is a problem in that mechanical strength is reduced.

The cross-linking agent reacts with the acrylamide and the hydroxyethyl acrylate to adjust mechanical strength of an ion gel electrode, and to stabilize a network structure. In an embodiment, the cross-linking agent may be poly(ethylene glycol) dimethacrylate (PEGDMA).

The poly(ethylene glycol) dimethacrylate is a cross-linking agent including a polyethylene glycol (PEG) chain and two methacrylate (—CH₂═C(CH₃)COO—) functional groups. Due to the inclusion of the polyethylene glycol (PEG) part, a more flexible network structure may be formed, so that an ion gel electrode has excellent stretchability, and has excellent ion conductivity by forming of a space in which ions may move.

The cross-linking agent may have a content of 0.3 mol % to 0.7 mol %, preferably 0.4 mol % to 0.6 mol %, based on the total content of the ion gel electrode composition for a dielectric heater. If the content of the cross-linking agent is too high, flexibility may be degraded and ion conductivity may be reduced, and if too low, mechanical properties may be reduced.

The ionic liquid (IL) is an ionic compound which maintains a liquid state at room temperature. The ionic liquid increases ion mobility within an electrode to maintain high ion conductivity. The ionic liquid may be 1-ethyl-3-methylimidazolium dicyanamide (EMIMDCA).

The ionic liquid may have a content of 300 parts by weight to 500 parts by weight, preferably 400 parts by weight, based on 100 parts by weight of the hydroxyethyl acrylate. If the content of the ionic liquid is too high, mechanical strength is reduced, and if too low, there is a problem in that ion conductivity is low.

The initiator initiates radical polymerization. In an embodiment, the initiator may be ammonium persulfate (APS). The ammonium persulfate has the chemical formula of (NH₄)₂S₂O₈, and is water-soluble, and thus may be easily mixed with the acrylamide and the hydroxyethyl acrylate, which are hydrophilic monomers, and may react with the poly(ethylene glycol) dimethacrylate to rapidly generate free radicals.

The initiator may have a content of 1 part by weight to 2 parts by weight, preferably 1 part by weight to 1.5 parts by weight, based on 100 parts by weight of the hydroxyethyl acrylate. If the content of the initiator is too high, a polymerization reaction rapidly occurs, so that flexibility may be degraded and ion conductivity may be lowered, and if too low, a polymer network may be non-uniformly formed.

The catalyst adjusts a radical polymerization rate and allows a polymer network to be uniformly formed. In an embodiment, the catalyst may be tetramethyl ethylenediamine (TEMED). The tetramethyl ethylenediamine has the chemical formula of C₆H₁₆N₂ and reacts with the ammonium persulfate (APS) to generate radicals, thereby increasing a radical initiation rate. In addition, the tetramethyl ethylenediamine is water-soluble, and thus may be easily mixed with the acrylamide and the hydroxyethyl acrylate.

The catalyst may have a content of 0.001 parts by weight to 0.005 parts by weight, preferably 0.0045 parts by weight, based on 100 parts by weight of the hydroxyethyl acrylate. If the content of the catalyst is too high, a polymerization reaction rapidly occurs, so that flexibility may be degraded and ion conductivity may be lowered, and if too low, a reaction rate decreases, so that a polymer network may be non-uniformly formed.

In accordance with another exemplary embodiment of the present invention, a method for manufacturing an ion gel electrode composition for a dielectric heater includes mixing acrylamide (AAm), hydroxyethyl acrylate (HEA), a cross-linking agent, and an ionic liquid to prepare a first mixture, adding an initiator and a catalyst to the first mixture to prepare a second mixture, and curing the second mixture.

In the step of preparing the first mixture, the acrylamide, the hydroxyethyl acrylate, the cross-linking agent, and the ionic liquid are the same as those described above, and the contents thereof to be added are the same as those described above.

The present step may be performed using a stirrer or a mixer commonly used, and in an embodiment, may be performed using a sonication device.

In the step of preparing the second mixture, the materials of the first mixture undergo a polymerization reaction. An initiator and a catalyst are added to the first mixture and mixed, and the initiator and the catalyst are the same as those described above. The present step may include a step of adding a small amount of water as a solvent to dissolve the initiator. In this case, the water may be added in an amount of a few drops.

The present step may be performed using a stirrer or mixer commonly used, and in an embodiment, may be performed using a sonication device.

In the present step, the second mixture may be in a pre-gel state. The pre-gel refers to a polymer mixture in a viscoelastic or free-flowing state formed in an intermediate stage of a reaction before being fully cured. The second mixture is in a state in which the acrylamide, the hydroxyethyl acrylate, the cross-linking agent, and the ionic liquid are uniformly dispersed, but a polymer network is not completely formed.

The curing step is a step of curing the second mixture in the pre-gel state so as to be in a gel state. In the present step, the acrylamide and the hydroxyethyl acrylate are polymerized through a reaction of the initiator and the catalyst, and a three-dimensional polymer network is formed by the cross-linking agent.

The present step may be performed using a curing machine, an oven, or the like commonly used, and in an embodiment, may be performed using a UV curing machine.

In accordance with another exemplary embodiment of the present invention, an ion gel electrode for a dielectric heater is manufactured using the above-described ion gel electrode composition for a dielectric heater. Ionic gel prepared by the above-described preparation method may be cut to an appropriate shape to be used as an ion gel electrode for a dielectric heater.

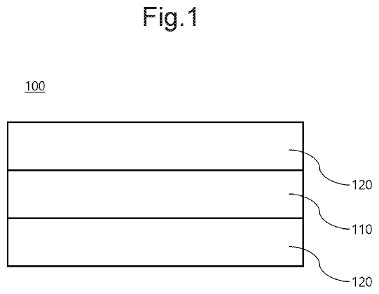

FIG. 1 is a conceptual diagram of a dielectric heater 100 according to an embodiment of the present invention. Referring to FIG. 1, the dielectric heater 100 according to an embodiment of the present invention includes a dielectric layer 110 and an ion gel electrode 120 for a dielectric heater disposed on each of one surface and the other surface of the dielectric layer 110.

The ion gel electrode for a dielectric heater is the same as described above.

The dielectric layer may be a gel-type polymer layer commonly used in the field of dielectric heaters. In an embodiment, the dielectric layer may be manufactured using PVC and may apply a current to the ion gel electrode for a dielectric heater to generate heat.

### Manufacturing Ion Gel Electrode for Dielectric Heater

Example 1: 0.05 g of acrylamide (Thermoscientific Co.), 0.5 g of hydroxyethyl acrylate (Daejung Co.), 0.0066 g of poly(ethylene glycol) dimethacrylate (PEGDMA) (TCI Co.) as a cross-linking agent, and 2.2 g of 1-ethyl-3-methylimidazolium dicyanamide (EMIMDCA) (iolitec Co.) as an ionic liquid were added to a sonication machine and mixed for 30 minutes. 0.0057 g of ammonium persulfate (Daejung Co. Ltd.) as an initiator, 0.00065 g of tetramethyl ethylenediamine (TEMED) (Alfa Aesar Co.) as a catalyst, and three drops of water were added to the mixture and stirred to create a pre-gel state. This was poured into a mold and cured in a UV curing machine for 60 minutes to manufacture an ion gel electrode.

Example 2: An ion gel electrode was manufactured in the same manner as in Example 1, except that 0.1 g of acrylamide, 0.5 g of hydroxyethyl acrylate, 0.0075 g of poly(ethylene glycol) dimethacrylate, 2.4 g of 1-ethyl-3-methylimidazolium dicyanamide, and 0.0065 g of ammonium persulfate were added.

Example 3: An ion gel electrode was manufactured in the same manner as in Example 1, except that 0.15 g of acrylamide, 0.5 g of hydroxyethyl acrylate, 0.0085 g of poly(ethylene glycol) dimethacrylate, 2.6 g of 1-ethyl-3-methylimidazolium dicyanamide, and 0.0073 g of ammonium persulfate were added.

Example 4: An ion gel electrode was manufactured in the same manner as in Example 1, except that 0.2 g of acrylamide, 0.5 g of hydroxyethyl acrylate, 0.0094 g of poly(ethylene glycol) dimethacrylate, 2.8 g of 1-ethyl-3-methylimidazolium dicyanamide, and 0.0081 g of ammonium persulfate were added.

Example 5: An ion gel electrode was manufactured in the same manner as in Example 1, except that 0.2 g of acrylamide, 1.0 g of hydroxyethyl acrylate, 0.0038 g of poly(ethylene glycol) dimethacrylate, 4.0 g of 1-ethyl-3-methylimidazolium dicyanamide, and 0.0156 g of ammonium persulfate were added.

Example 6: An ion gel electrode was manufactured in the same manner as in Example 1, except that 0.1 g of acrylamide, 0.5 g of hydroxyethyl acrylate, 0.0094 g of poly(ethylene glycol) dimethacrylate, 2.0 g of 1-ethyl-3-methylimidazolium dicyanamide, and 0.0078 g of ammonium persulfate were added.

Example 7: An ion gel electrode was manufactured in the same manner as in Example 1, except that 0.1 g of acrylamide, 0.5 g of hydroxyethyl acrylate, 0.0189 g of poly(ethylene glycol) dimethacrylate, 2.0 g of 1-ethyl-3-methylimidazolium dicyanamide, and 0.0078 g of ammonium persulfate were added.

Example 8: An ion gel electrode was manufactured in the same manner as in Example 1, except that 0.1 g of acrylamide, 0.5 g of hydroxyethyl acrylate, 0.0283 g of poly(ethylene glycol) dimethacrylate, 2.0 g of 1-ethyl-3-methylimidazolium dicyanamide, and 0.0078 g of ammonium persulfate were added.

Example 9: An ion gel electrode was manufactured in the same manner as in Example 1, except that 0.2 g of acrylamide, 1.0 g of hydroxyethyl acrylate, 0.0170 g of poly(ethylene glycol) dimethacrylate, 1.0 g of 1-ethyl-3-methylimidazolium dicyanamide, and 0.0078 g of ammonium persulfate were added.

Example 10: An ion gel electrode was manufactured in the same manner as in Example 1, except that 0.2 g of acrylamide, 1.0 g of hydroxyethyl acrylate, 0.0170 g of poly(ethylene glycol) dimethacrylate, 2.0 g of 1-ethyl-3-methylimidazolium dicyanamide, and 0.0078 g of ammonium persulfate were added.

Example 11: An ion gel electrode was manufactured in the same manner as in Example 1, except that 0.2 g of acrylamide, 1.0 g of hydroxyethyl acrylate, 0.0170 g of poly(ethylene glycol) dimethacrylate, 3.0 g of 1-ethyl-3-methylimidazolium dicyanamide, and 0.0078 g of ammonium persulfate were added.

Example 12: An ion gel electrode was manufactured in the same manner as in Example 1, except that 0.2 g of acrylamide, 1.0 g of hydroxyethyl acrylate, 0.0170 g of poly(ethylene glycol) dimethacrylate, 4.0 g of 1-ethyl-3-methylimidazolium dicyanamide, and 0.0078 g of ammonium persulfate were added.

Example 13: An ion gel electrode was manufactured in the same manner as in Example 1, except that 0.2 g of acrylamide, 1.0 g of hydroxyethyl acrylate, 0.0170 g of poly(ethylene glycol) dimethacrylate, 5.0 g of 1-ethyl-3-methylimidazolium dicyanamide, and 0.0078 g of ammonium persulfate were added.

The content of each material in Examples 1 to 13 is as shown in the table below.

TABLE 1

| | Example | Example | Example | Example | Example | Example | Example |
|---|---|---|---|---|---|---|---|
| Components | 1 | 2 | 3 | 4 | 5 | 6 | 7 |
| HEA | 0.5 | 0.5 | 0.5 | 0.5 | 1 | 0.5 | 0.5 |
| AAm | 0.05 | 0.1 | 0.15 | 0.2 | 0.2 | 0.1 | 0.1 |
| PEGDMA | 0.0066 | 0.0075 | 0.0085 | 0.0094 | 0.0038 | 0.0094 | 0.0189 |
| IL | 2.2 | 2.4 | 2.6 | 2.8 | 4 | 2 | 2 |
| APS | 0.0057 | 0.0065 | 0.0073 | 0.0081 | 0.0156 | 0.0078 | 0.0078 |

| | Example | Example | Example | Example | Example | Example |
|---|---|---|---|---|---|---|
| Components | 8 | 9 | 10 | 11 | 12 | 13 |
| HEA | 0.5 | 1 | 1 | 1 | 1 | 1 |
| AAm | 0.1 | 0.2 | 0.2 | 0.2 | 0.2 | 0.2 |
| PEGDMA | 0.0283 | 0.017 | 0.017 | 0.017 | 0.017 | 0.017 |
| IL | 2 | 1 | 2 | 3 | 4 | 5 |
| APS | 0.0078 | 0.0078 | 0.0078 | 0.0078 | 0.0078 | 0.0078 |

Examples 1 to 4 are for experiments to optimize the content ratio of the acrylamide and the hydroxyethyl acrylate. According to a combined weight of the acrylamide and the hydroxyethyl acrylate, the other materials were each added in a content also increased in the same proportion.

Examples 5 to 8 are for experiments to optimize the content ratio of the cross-linking agent. In Examples 5 to 8, the cross-linking agent has a molar ratio of 0.1 mol %, 0.5 mol %, 1.0 mol %, and 1.5 mol %, respectively.

Examples 9 to 13 are for experiments to optimize the content ratio of the ionic liquid.

In the following experimental examples, the ion gel electrodes of Examples 1 to 13 are denoted as P(H₁A_{0.1})_{0.5}_4, P(H₁A_{0.2})_{0.5}_4, P(H₁A_{0.3})_{0.5}_4, P(H₁A_{0.4})_{0.5}_4, P(H₁A_{0.2})_{0.1}_4, P(H₁A_{0.2})_{0.5}_4, P(H₁A_{0.2})_{1.0}_4, P(H₁A_{0.2})_{1.5}_4, P(H₁A_{0.2})_{1.5}_1, P(H₁A_{0.2})_{1.5}_2, P(H₁A_{0.2})_{1.5}_3, P(H₁A_{0.2})_{1.5}_4, and P(H₁A_{0.2})_{1.5}_5, respectively.

### Manufacturing of Hydrogel Electrode

A hydrogel electrode is aqueous-based gel, and was manufactured as a control group for Examples by adding water, unlike Examples. 1.98 g of acrylamide as a monomer, 0.0021 g of a cross-linking agent (N,N′-Methylenebis(acrylamide)), 2.38 g of LiCl as a lithium salt, 0.0056 g of APS as an initiator, and 0.00655 g of TEMED as a catalyst were added to 5.6323 g of water and mixed, and then the mixture was poured into a mold and cured in a UV curing machine for 20 minutes to manufacture a hydrogel electrode.

### Manufacturing of Dielectric Layer

0.4 g of polyvinyl chloride (PVC) (Thermo Scientific Co.) was added to 40 mL of tetrahydrofuran (THF) and dissolved. 2.4 g of dibutyl adipate (DBA) (TCI Co.) and 0.012 g of benzophenone (TCI Co.) were added thereto, and the mixture was placed in a sonication machine and mixed for 30 minutes. This was poured into a Petri dish and subjected to solution casting for 24 hours to manufacture a dielectric layer.

### Manufacturing of Dielectric Heater

The ion gel electrodes manufactured in Examples 1 to 13 and the hydrogel electrode were respectively attached to each of one surface and the other surface of the dielectric layer manufactured above, and a power source was connected thereto to manufacture a dielectric heater.

### Experimental Example: Observation of Ion Gel Electrode State

The ion gel electrode manufactured in each of Examples was bonded to the dielectric layers manufactured above to confirm the bonded state thereof, and the color of the ion gel electrode was observed with the naked eye. In the case of the bonded state, in the case of Example 1 (P(H₁A_{0.1})_{0.5}_4) and Example 13 (P(H₁A_{0.2})_{1.5}_5), the dielectric layer and the ion gel electrode were not bonded to each other, making it difficult to apply the same as an ion gel electrode. In the case of the color, the ion gel electrodes gradually became cloudy in Example 3 (P(H₁A_{0.3})_{0.5}_4) and Example 4 (P(H₁A_{0.4})_{0.5}_4), resulting in decreased transparency. It is considered that when the content of the acrylamide is low, the number of amide groups decreases, making attachment difficult, and when the content of the acrylamide is high, acrylamide does not dissolve well in the ionic liquid, causing cloudy appearance.

### Experimental Example: Measurement of Ion Conductivity

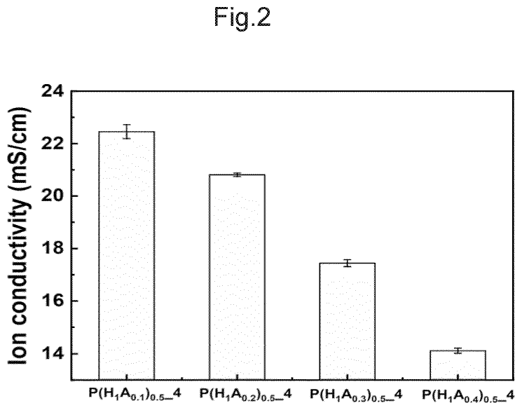

Examples 1 to 13 were measured for ion conductivity by using an SP240 (Biologic Science Instrument Co.) impedance analyzer (Electrochemical Impedance Spectroscopy (EIS)). The measurement frequency range was 10⁵ Hz to 10⁻¹ Hz, and the applied AC voltage was 10 mV. The experimental results are illustrated in FIG. 2 to FIG. 4.

Referring to FIG. 2, it can be seen that the ion conductivity decreases as the content of the acrylamide increases.

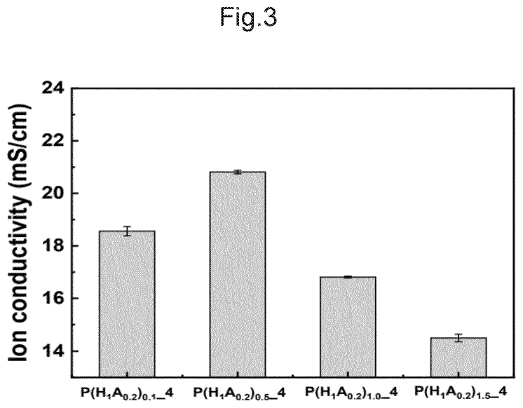

Referring to FIG. 3, Example 6 (P(H₁A_{0.2})_{0.5}_4) having a cross-linking agent content of 0.5 mol % exhibited the highest ion conductivity.

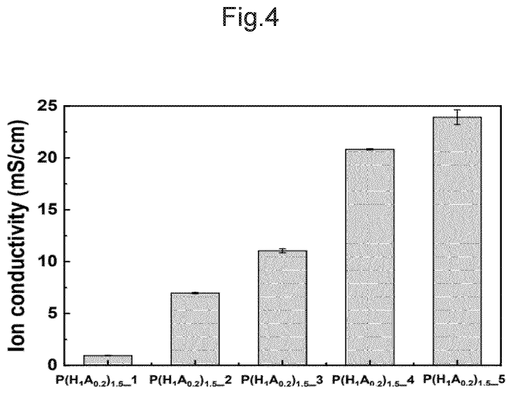

Referring to FIG. 4, the ion conductivity increased as the content of the ionic liquid increased.

### Experimental Example: Tensile Test

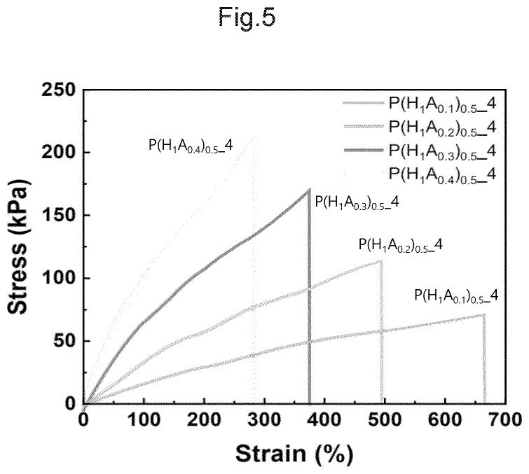

For Examples 1 to 13, mechanical properties of the ion gel electrodes were evaluated using a Tinius Olsen universal testing machine (UTM). The test complied with ASTM-D638 standards, and the test rate was set at 50 mm/min. The experimental results are illustrated in FIG. 5 to FIG. 7.

Referring to FIG. 5, as the content of the acrylamide increased, strength increased but flexibility decreased.

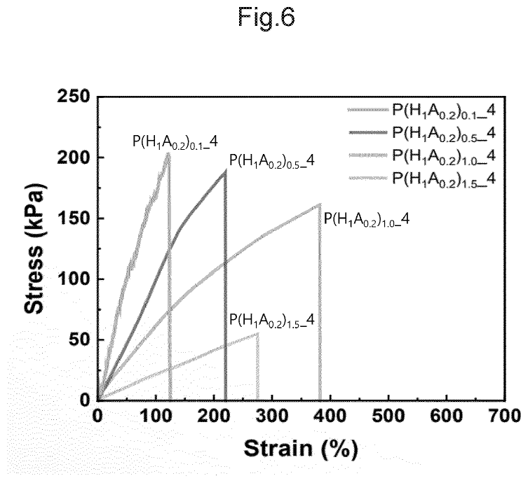

Referring to FIG. 6, in Examples 5, 6, and 7 (P(H₁A_{0.2})_{0.1}_4, P(H₁A_{0.2})_{0.5}_4, and P(H₁A_{0.2})_{1.0}_4), as the content of the cross-linking agent increased, the strength decreased and the flexibility increased, but in Example 8 (P(H₁A_{0.2})_{1.5}_4), both the strength and the flexibility significantly decreased.

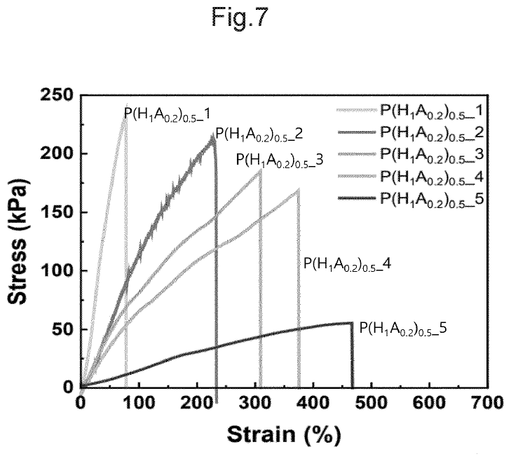

Referring to FIG. 7, as the content of the ionic liquid increased, the strength decreased and the flexibility increased, and in the case of Example 13 (P(H₁A_{0.2})_{1.5}_5), the strength significantly decreased, making it difficult to apply the same as an ion gel electrode.

Referring to the experimental results of FIG. 2 to FIG. 7, in Example 2 (P(H₁A_{0.2})_{0.5}_4) having a content ratio of the acrylamide to the hydroxyethyl acrylate of 1:5, the bonding strength and the light transmittance were excellent, and the ion conductivity, the strength, and the flexibility were within appropriate ranges, so that the content ratio thereof was most suitable. In Example 6 (P(H₁A_{0.2})_{0.5}_4) having a cross-linking agent content of 0.5 mol %, the ion conductivity was the best, and the strength and the flexibility were within appropriate ranges, so that the content thereof was the most suitable. In Example 12 (P(H₁A_{0.2})_{1.5}_4) having an ionic liquid content of 400 parts by weight based on 100 parts by weight of the hydroxyethyl acrylate, the bonding strength was excellent, and the ionic conductivity, the strength, and the flexibility were within appropriate ranges, so that the content thereof was the most suitable.

### Experimental Example: Thermogravimetric Analysis (TGA)

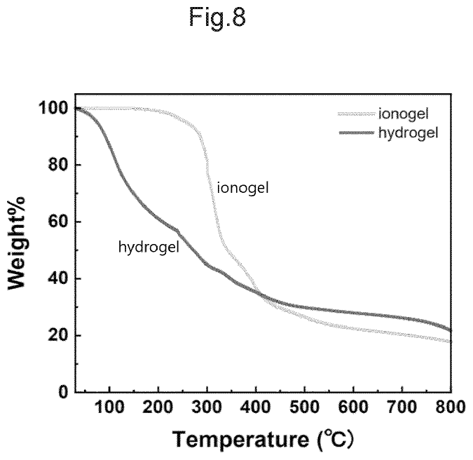

For Example 2 (P(H₁A_{0.2})_{0.5}_4) and the hydrogel electrode, thermal properties of samples were analyzed using a TGA 4000 apparatus of Perkin Elmer Co. The analysis was performed at a temperature raising rate of 10° C./min. The experimental results are illustrated in FIG. 8. Example 2 is denoted as “ionogel,” and the hydrogel electrode is denoted as “hydrogel.”

Referring to FIG. 8, Example 2 (P(H₁A_{0.2})_{0.5}_4) has a degradation temperature of 300° C. or higher, which is significantly higher than a degradation temperature of 62° C. of the hydrogel.

### Experimental Example: T-Peel Test

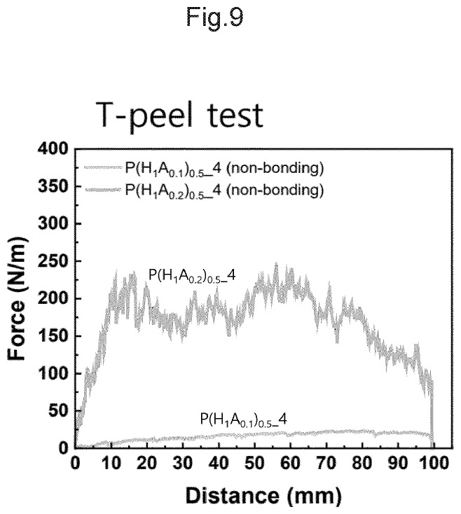

For Example 1 (P(H₁A_{0.1})_{0.5}_4) and Example 2 (P(H₁A_{0.2})_{0.5}_4), a T-peel test was performed using a Tinius Olsen universal testing machine (UTM). The experimental results are illustrated in FIG. 9.

Referring to FIG. 9, Example 1 (P(H₁A_{0.1})_{0.5}_4) having a low acrylamide content failed to form a covalent bond, which is interpreted as having difficulty bonding with the dielectric layer.

### Experimental Example: Transmittance Analysis

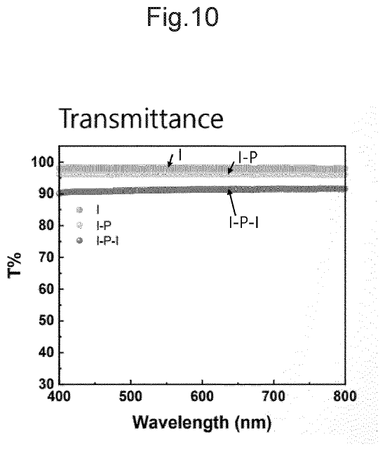

For Example 2 (P(H₁A_{0.2})_{0.5}_4), one prepared by bonding Example 2 and the dielectric layer together, and one prepared by bonding Example 2, the dielectric layer, and Example 2 to each other in that order, transmittance of samples was measured in the range of 400 nm to 800 nm using a Mega-800 UV-Vis spectrophotometer of Scinco Co. The measurement results are illustrated in FIG. 10.

Referring to FIG. 10, all three samples exhibited a transmittance of greater than 90%.

### Experimental Example: Evaluation of Heat Generation Performance

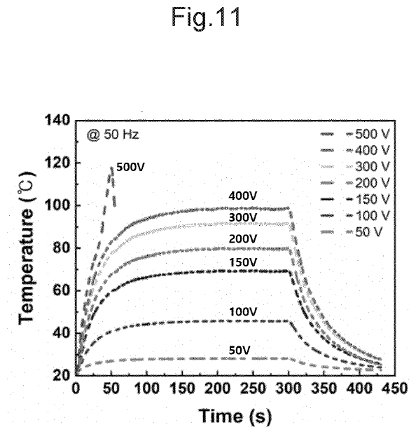

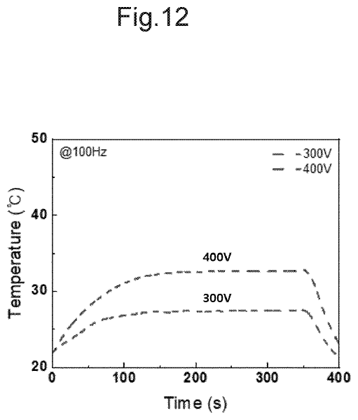

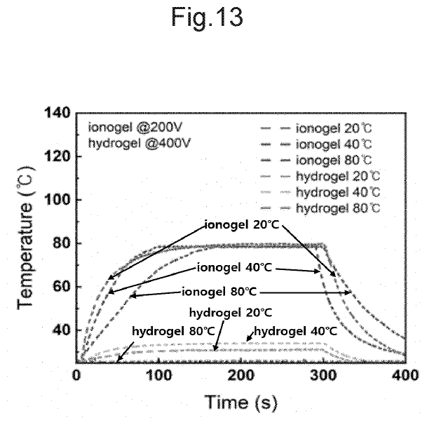

The dielectric heater manufactured using Example 2 (P(H₁A_{0.2})_{0.5}_4) and the dielectric heater manufactured using the hydrogel electrode were used to evaluate heat generation performance as a function of voltage. The performance evaluation was performed using a FLIR thermal imaging camera (TELEDYNE), and FIG. 11 and FIG. 12 respectively show evaluation results for the dielectric heater applied with Example 2 and the dielectric heater applied with the hydrogel electrode, and FIG. 13 shows evaluation results under harsh conditions.

Referring to FIG. 11 to FIG. 13, the one applied with Example 2 exhibited better performance at low voltages and maintained performance similar to that at room temperature even under harsh conditions. The one applied with the hydrogel electrode exhibited degraded performance at high temperatures since water thereinside evaporated, leading to reduced mobility of lithium ions.

### Experimental Example: Evaluation of Electrical Properties

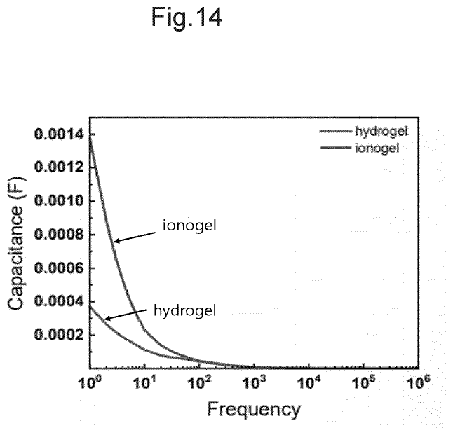

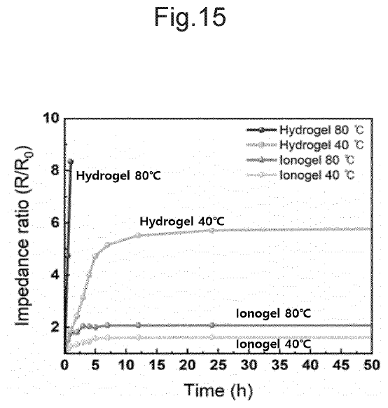

The dielectric heater manufactured using Example 2 (P(H₁A_{0.2})_{0.5}_4) and the dielectric heater manufactured using the hydrogel electrode were used to measure changes in capacitance and in impedance under harsh conditions. The evaluation was performed using an impedance analyzer, SP240, and the results are respectively illustrated in FIG. 14 and FIG. 15.

Referring to FIG. 14, it can be seen that the one applied with Example 2 has a higher capacitance. Referring to FIG. 15, it can be seen that the one applied with Example 2 shows almost no change under various temperature conditions, and thus is stable, but the one applied with the hydrogel electrode shows changes in impedance.

### Experimental Example: Evaluation of Durability of Dielectric Heater

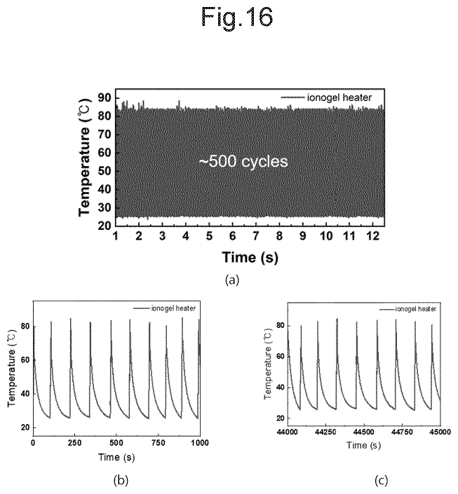

The dielectric heater manufactured using Example 2 (P(H₁A_{0.2})_{0.5}_4) was used to evaluate durability. FIG. 16 illustrates the temperature measured during operation of the dielectric heater over 650 cycles (a), and the temperature measured between 0 second to 1000 seconds and between 44000 seconds to 45000 seconds.

Referring to FIG. 16, it can be seen that it is possible to provide a dielectric heater having excellent durability by applying the ion gel electrode according to an embodiment of the present invention.

An ion gel electrode composition for a dielectric heater and a method for manufacturing the same according to embodiments of the present invention may provide an ion gel electrode for a dielectric heater having high elongation and electrical stability.

In addition, the present invention has excellent electrical properties and ion conductivity.

In addition, the present invention may provide uniform heat distribution and improved heater performance.

The present invention is not limited by the above-described embodiments and the accompanying drawings, but is intended to be limited by the appended claims. Accordingly, various types of substitutions, modifications, and changes may be made by those skilled in the art within the scope not departing from the technical spirit of the present disclosure described in the claims, and these substitutions, modifications, and changes may also belong to the scope of the present disclosure.

What is claimed is:

1. An ion gel electrode composition for a dielectric heater, the ion gel electrode composition comprising:
acrylamide (AAm);
hydroxyethyl acrylate (HEA);
a cross-linking agent; and
an ionic liquid.

2. The ion gel electrode composition for a dielectric heater of claim 1, wherein the acrylamide and the hydroxyethyl acrylate have a weight ratio of 1:3 to 1:10.

3. The ion gel electrode composition for a dielectric heater of claim 1, wherein the cross-linking agent has a content of 0.3 mol % to 0.7 mol % based on the total content of the ion gel electrode composition for a dielectric heater.

4. The ion gel electrode composition for a dielectric heater of claim 1, wherein the ionic liquid has a content of 300 parts by weight to 500 parts by weight based on 100 parts by weight of the hydroxyethyl acrylate.

5. The ion gel electrode composition for a dielectric heater of claim 1, further comprising ammonium persulfate (APS) as an initiator and tetramethyl ethylenediamine (TEMED) as a catalyst.

6. A method for manufacturing an ion gel electrode composition for a dielectric heater, the method comprising:
mixing acrylamide (AAm), hydroxyethyl acrylate (HEA), a cross-linking agent, and an ionic liquid to prepare a first mixture;
adding an initiator and a catalyst to the first mixture to prepare a second mixture; and
curing the second mixture.

7. An ion gel electrode for a dielectric heater, the ion gel electrode manufactured using the ion gel electrode composition for a dielectric heater of claim 1.

8. A dielectric heater comprising a dielectric layer and the ion gel electrode for a dielectric heater of claim 7 disposed on each of one surface and the other surface of the dielectric layer.
